(19) United States
(12) Patent Application Publication
(10) Pub. No.: US 2026/0139905 A1
(43) Pub. Date: May 21, 2026

(54) DUAL VOLUTE, REVERSIBLE PUMP FOR PUMPING MOLTEN METAL

(71) Applicant: Niklaus Thut, Chagrin Falls, OH (US)

(72) Inventor: Niklaus Thut, Chagrin Falls, OH (US)

(21) Appl. No.: 18/951,343

(22) Filed: Nov. 18, 2024

(51) Int. Cl. F27D 3/14; F27D 3/00; F27D 27/00

(52) U.S. Cl. CPC F27D 3/14; F27D 27/005; F27D 2003/0054

(57) ABSTRACT

A pump for pumping molten metal includes a refractory base including at least one inlet, a first outlet, a second outlet, a first volute chamber and a second volute chamber disposed above the first volute chamber. The first volute chamber includes a first volute that is constructed and arranged in a first volute orientation in a top view. The second volute chamber includes a second volute that is constructed and arranged in a second volute orientation opposite to the first volute orientation in a top view. The pump includes a motor driven, refractory shaft and an impeller connected to an end portion of the refractory shaft. The impeller is rotated in the first volute in one rotational direction relative to a top view to direct molten metal through the first outlet. The impeller is vertically moved and rotated in the second volute in an opposite rotational direction relative to a top view to direct molten metal through the second outlet.

### TECHNICAL FIELD:

The field is pumps for pumping molten metal.

### BACKGROUND OF THE DISCLOSURE

A dual-volute, two position pump (known as the Chameleon® pump made by High Temperature Systems, Inc.) shown in FIG. 1 has two internal chambers known as volute chambers. The pump is designed to spin an impeller in one of the two volute chambers at any given time, to output molten metal fluid to a destination associated with each individual volute. For example, volute chamber A may output to a chip melting system or to circulate a furnace, and volute chamber B may be designated to transfer molten metal out of the furnace.

A problem arises when one of the two outputs is designated to transfer molten metal out of the furnace. When spinning the impeller inside of volute chamber A (shown in FIG. 2), drag is imparted on the fluid surrounding the shaft and impeller, and all surrounding fluid begins to spin in the direction of rotation of the shaft/impeller. This even causes spinning of the fluid inside volute chamber B that contains no spinning impeller (shown in FIG. 3). Volute chamber A (FIG. 2) is referred to herein as an “active” volute chamber, with the impeller spinning in volute chamber A, pushing fluid out through output 1. Volute chamber B (FIG. 3) is referred to herein as an “inactive” volute chamber, as it contains no spinning impeller. FIG. 3 shows molten metal flow in the inactive chamber B as a result of the impeller spinning in the active volute chamber A (the impeller not being shown in FIG. 3 for clarity).

Although the molten metal fluid is rotating at a significantly lower velocity magnitude in inactive volute chamber B, this rotation can still cause problems. For either of these two volute chambers to be able to transfer fluid out of the furnace, it must include a transfer riser (or other structure able to direct fluid) through which the molten metal fluid is able to move vertically up above the resting metal line (the level of molten metal inside the transfer riser when the pump is off). This rotation of the molten metal fluid inside of the inactive volute chamber will cause both pressure and flow to occur inside of the riser, as the fundamental act of rotating fluid inside of a volute creates a pumping effect. When a transfer riser is attached to this inactive volute chamber, and the pumping effect occurs, one of two things is likely to happen. If the pressure and flow are high enough, it is possible to pump fluid out of the transfer side of this pump without intending to, leading to potentially dangerous metal spills. If the pressure and the flow are not high enough to pump molten metal fluid out of the transfer riser, it may still be raising the molten metal level inside of the transfer riser above the resting metal line. In this case, the molten metal raised inside of the transfer riser above the resting metal line may cool and solidify, blocking the passageway through the transfer riser, and eliminating the functionality of the transfer side of the pump, as the blockage will cause the transfer side to be unable to pump.

### SUMMARY OF THE DISCLOSURE

Pumps are biased to rotate the impeller in a singular direction, dictated by both designs of the volute and the impeller. A person of ordinary skill in the art can identify the intended direction of rotation by simply looking at both components. Refer to FIG. 2 of Michael-Smith-Engineers.co, UK, which is designed so that the volute is biased in the counter-clockwise direction. In FIG. 2 of Michael-Smith-Engineers.co.UK, if you were to reverse the rotation of the impeller inside of the volute casing to clockwise, contrary to its intended design, the flow out of the outlet would be significantly lower, and efficiency decreased. While it may still pump, it would not do so with the intended performance. This is because the direction of flow to the outlet would be opposite to the direction of rotation of the impeller and opposite to its volute orientation and impeller design intended for that direction of flow and direction of impeller rotation. It should be noted that reversing the rotation of the impeller will not cause the pump's outlet to become an inlet in the case of a centrifugal pump, as the inlet of a centrifugal pump is axial to the direction of rotation.

The present disclosure uses the fact that the volute shape is biased towards a certain direction for higher efficiency, and changes the bias direction to be different in the two volute chambers. In the prior art pump, both volutes A and B are biased towards a clockwise direction. In contrast, according to this disclosure, in order to reduce the impact of the induced molten metal rotation inside the inactive chamber, the volute of the inactive chamber (second volute) is biased in an opposite direction as the other volute (first volute).

Moreover, in this disclosure the motor is designed so that the impeller is rotated in one direction relative to a top view in the first volute and is rotated in a second opposite direction relative to a top view in the second volute. This enables the impeller rotating in the second impeller chamber to achieve suitable transfer pumping efficiency relative to the second volute bias direction (the impeller rotating in the same direction as the bias direction of the second volute in the active state), which is opposite to the first volute bias direction and first rotational direction.

Embodiments and specific features of the disclosure will now be described. In a general embodiment of the disclosure a pump for pumping molten metal includes a refractory base including at least one inlet, a first outlet, a second outlet, a first volute chamber and a second volute chamber disposed above the first volute chamber. The first volute chamber includes a first volute that is constructed and arranged in a first volute orientation in a top view. The second volute chamber includes a second volute that is constructed and arranged in a second volute orientation opposite to the first volute orientation in a top view. The pump includes a motor driven, refractory shaft and an impeller connected to an end portion of the refractory shaft. The impeller is rotated in the first volute in one rotational direction relative to a top view to direct molten metal through the first outlet. The impeller is vertically moved and rotated in the second volute in an opposite rotational direction relative to a top view to direct molten metal through the second outlet.

Referring now to specific features of the general embodiment, present or not and in any combination, a transfer riser extends from the base outside the molten metal for molten metal transfer. The first outlet is a discharge opening of the base and the second outlet is an outlet from the base extending into the transfer riser.

In another feature a system includes the pump above and comprises a vortexer vessel located adjacent to the base and comprises at least one well of a furnace in which the pump and the vortexer vessel are partially submerged, wherein molten metal from the first outlet is directed into the vortexer vessel effective to create a vortex that pulls metal scrap down into the vortexer vessel for melting the scrap.

Yet another feature is the system wherein molten metal traveling through the first outlet is directed into a bowl of the vortexer vessel, the vortex of molten metal is formed in the bowl, the molten metal outlets from the bowl and circulates through the furnace.

Yet another feature is that the system includes the vortexer vessel that includes an inlet opening into a bowl of the vortexer vessel along which the molten metal is inlet from the pump into the bowl. The inlet opening is substantially tangential to a side wall of the bowl.

In another feature the transfer riser is connected to conduit or a launder that extends to be adapted to discharge at a remote location.

Another feature is that the first rotational direction is clockwise relative to the top view and the second rotational direction is counterclockwise relative to the top view.

Still further, a feature is that the pump includes a lifting mechanism for carrying out the vertical movement of the impeller, which vertically moves the shaft and the impeller between one vertical position in the first volute and another vertical position in the second volute.

Another feature is that the impeller is selected from one of the following: the impeller includes a plurality of straight vanes, straight passages or a combination thereof, wherein the straight vanes or straight passages extend along the shaft and normal to the shaft radially outward from near a center portion of the impeller; the impeller has curved vanes; and the impeller has vanes with faces that extend outward from and substantially tangential to a central portion of the impeller.

A second embodiment of the disclosure features a pump for pumping molten metal including a refractory base including at least one inlet, a first outlet, a second outlet, and a transfer riser extending from the base outside the molten metal for molten metal transfer. The first outlet is a discharge opening of the base. The second outlet is an outlet from the base extending into the transfer riser. The base includes a first volute chamber and a second volute chamber disposed above the first volute chamber. The first volute chamber includes a first volute that is constructed and arranged in a first volute orientation in a top view. The second volute chamber includes a second volute that is constructed and arranged in a second volute orientation opposite to the first volute orientation in a top view. The pump includes a motor driven, refractory shaft and an impeller connected to an end portion of the refractory shaft. An impeller is rotated in the first volute in a first rotational direction relative to a top view to direct molten metal through the first outlet. The impeller is vertically moved and rotated in the second volute in a second rotational direction opposite to the first rotational direction relative to a top view to direct molten metal through the second outlet. A rotating an impeller in the first volute or the second volute is an active volute and lack of a rotating impeller in the first volute or the second volute is an inactive volute. Rotation of the impeller in the first volute, as the active volute, causes a direction of substantial flow of molten metal in the second volute that is the inactive volute. However, travel of the molten metal up the transfer riser is impeded by the second volute orientation, as the inactive volute, that is opposite to the direction of substantial flow in the second volute.

Referring to specific features of the second embodiment, present or not and in any combination, the pump includes a lifting mechanism for carrying out the vertical movement of the impeller that vertically moves the shaft and the impeller between one vertical position in the first volute and another vertical position in the second volute.

In another feature a system includes the pump of the second embodiment above and comprises a vortexer vessel located adjacent to the base and comprises at least one well of a furnace in which the pump and the vortexer vessel are partially submerged, wherein molten metal from the first outlet is directed into the vortexer vessel effective to create a vortex that pulls metal scrap down into the vortexer vessel for melting the scrap.

Yet another feature is the system wherein molten metal traveling through the first outlet is directed into a bowl of the vortexer vessel, the vortex of molten metal is formed in the bowl, the molten metal outlets from the bowl and circulates through the furnace.

Yet another feature is that the system includes the vortexer vessel that includes an inlet opening into a bowl of the vortexer vessel along which the molten metal is inlet from the pump into the bowl. The inlet opening is substantially tangential to a side wall of the bowl.

A feature is that the transfer riser is connected to conduit or a launder that extends to discharge into a movable vessel.

A further feature is that the first rotational direction is clockwise relative to the top view and the second rotational direction is counterclockwise relative to the top view.

Another feature is that the impeller is selected from one of the following: the impeller includes a plurality of straight vanes, straight passages or a combination thereof, wherein the straight vanes or straight passages extend along the shaft and normal to the shaft radially outward from near a center portion of the impeller; the impeller has curved vanes; and the impeller has vanes with faces that extend outward from and substantially tangential to a central portion of the impeller.

A third embodiment of the disclosure features a pump for pumping molten metal including a refractory base including at least one inlet, a first outlet, a second outlet, a first impeller chamber and a second impeller chamber disposed above the first impeller chamber. The first impeller chamber is substantially voluteless or includes a first volute and the second impeller chamber includes a second volute. If used, the first volute has a first volute orientation that is opposite to the second volute orientation. The pump includes a motor driven, refractory shaft and an impeller connected to an end portion of the refractory shaft. The impeller is rotated in the first impeller chamber in one rotational direction relative to a top view to direct molten metal through the first outlet. The impeller is vertically moved and rotated in the second volute in an opposite rotational direction relative to a top view to direct molten metal through the second outlet. A rotating of the impeller in the first impeller chamber or the second impeller chamber is an active impeller chamber and lack of a rotating impeller in the first impeller chamber or the second impeller chamber is an inactive impeller chamber. Rotation of the impeller in the first impeller chamber, as the active impeller chamber, causes a direction of substantial flow of molten metal in the second impeller chamber, as the inactive impeller chamber. However, travel of the molten metal up the transfer riser is impeded by the second volute orientation that is opposite to the direction of substantial flow in the second impeller chamber.

Referring now to specific features of the third embodiment, present or not and in any combination, a transfer riser extends from the base outside the molten metal for molten metal transfer. The first outlet is a discharge opening of the base and the second outlet is an outlet from the base extending into the transfer riser.

In another feature a system includes the pump above and comprises a vortexer vessel located adjacent to the base and comprises at least one well of a furnace in which the pump and the vortexer vessel are partially submerged, wherein molten metal from the first outlet is directed into the vortexer vessel effective to create a vortex that pulls metal scrap down into the vortexer vessel for melting the scrap.

Yet another feature is the system wherein molten metal traveling through the first outlet is directed into a bowl of the vortexer vessel, the vortex of molten metal is formed in the bowl, the molten metal outlets from the bowl and circulates through the furnace.

Yet another feature is that the system includes the vortexer vessel that includes an inlet opening into a bowl of the vortexer vessel along which the molten metal is inlet from the pump into the bowl. The inlet opening is substantially tangential to a side wall of the bowl.

Still further, a feature is that the transfer riser is connected to conduit or a launder that extends to be adapted to discharge into a movable vessel.

Further is the feature in which the pump includes a lifting mechanism for carrying out the vertical movement of the impeller that vertically moves the shaft and the impeller between one vertical position in the first impeller chamber and another vertical position in the second impeller chamber.

Another feature is that the impeller is selected from one of the following: the impeller includes a plurality of straight vanes, straight passages or a combination thereof, wherein the straight vanes or straight passages extend along the shaft and normal to the shaft radially outward from near a center portion of the impeller; the impeller has curved vanes; and the impeller has vanes with faces that extend outward from and substantially tangential to a central portion of the impeller.

It should be understood that the above Summary of the Disclosure describes embodiments of the disclosure in broad terms while the following Detailed Description describes embodiments of the disclosure more narrowly and presents specific embodiments that should not be construed as necessary limitations of the invention as broadly defined in the claims. Many additional features, advantages and a fuller understanding of the disclosure will be had from the accompanying drawings and the Detailed Description that follows.

### BRIEF DESCRIPTION OF THE DRAWINGS:

PRIOR ART FIG. 1 is a perspective view of a prior art, dual volute pump for pumping molten metal;

PRIOR ART FIG. 2 is a top view of volute A of the pump of FIG. 1 in an active state, biased in the clockwise direction showing molten metal velocity, showing a spectrum of colors and corresponding velocity magnitudes, with cooler colors representing slower velocity magnitude than warmer colors, blue being coolest/slowest and red the hottest/fastest;

PRIOR ART FIG. 3 is a top view of volute B of the pump of FIG. 1 in the inactive state, biased in the clockwise direction, showing molten metal velocity, showing a spectrum of colors and corresponding velocity magnitudes, with cooler colors representing slower velocity magnitude than warmer colors, blue being coolest/slowest and red the hottest/fastest;

FIG. 4 is a perspective view of a system of pumping molten metal and melting scrap of the present disclosure;

FIG. 5 is a top view of the vortexer vessel of FIG. 4;

FIG. 6 is a vertical cross-sectional view taken along cutting lines and seen along the arrows 6-6 of FIG. 5;

FIG. 7 is a vertical cross-sectional view of the base of FIG. 4 showing stacked volute chambers in which a lower volute chamber is active and an upper volute chamber is inactive;

FIG. 8 is a cross-sectional, top view from the cutting plane shown by the cutting line and arrows 8-8 of FIG. 7 showing a first volute chamber in an active state;

FIGS. 9-11 are views of an impeller of the disclosure;

FIG. 12 is a cross-sectional, top view from the cutting plane shown by the cutting line and arrows 12-12 of FIG. 7 showing a second (e.g., upper) volute chamber in an inactive state;

FIG. 13 is a close-up view of the second impeller chamber and second outlet showing velocity and static pressure, wherein velocity is indicated by arrow size and pressure by color in the legend shown;

FIG. 14 describes an angle of a tangential passage between the second impeller chamber of FIG. 13 and the second outlet;

FIG. 15 is a cross sectional view directed to another embodiment of the present disclosure and shows the first volute chamber in an active state;

FIG. 16 is a cross-sectional view directed to the other embodiment of the present disclosure and shows the second volute chamber in an active state;

FIG. 17 shows velocity magnitude of the first volute chamber of FIG. 15 in the active state, showing a spectrum of colors and corresponding velocity magnitudes, with cooler colors representing slower velocity magnitude than warmer colors, blue being coolest/slowest and red the hottest/fastest; and

FIG. 18 shows velocity magnitude of the second volute chamber of FIG. 16 in the inactive state, showing a spectrum of colors and corresponding velocity magnitudes, with cooler colors representing slower velocity magnitude than warmer colors, blue being coolest/slowest and red the hottest/fastest.

### DETAILED DESCRIPTION:

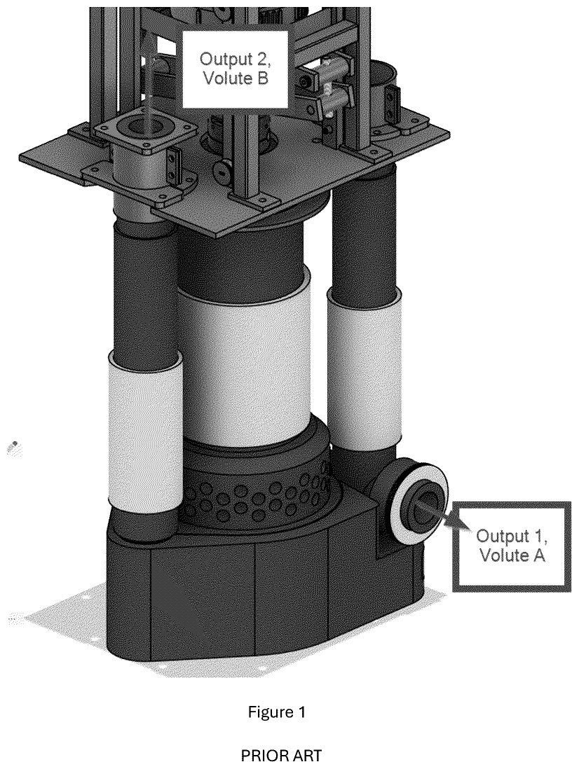

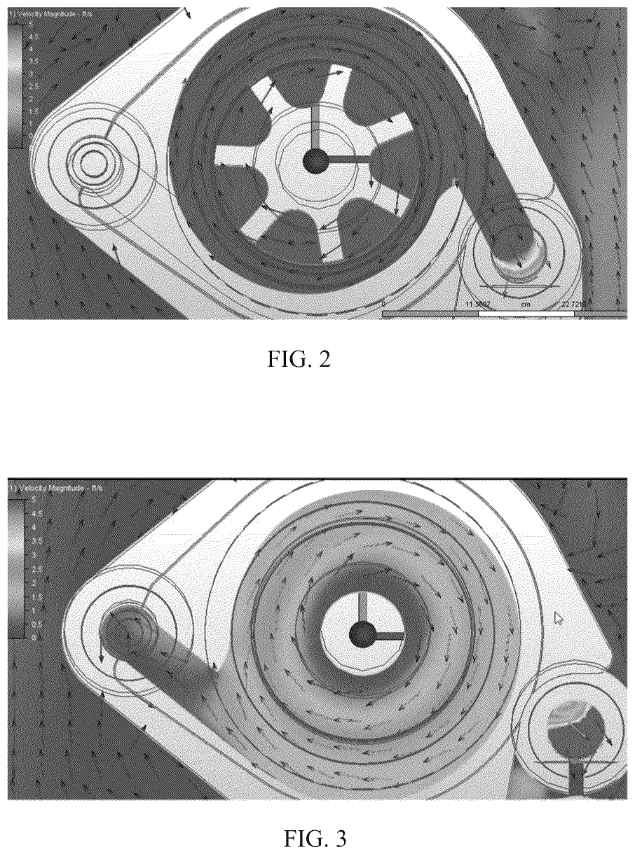

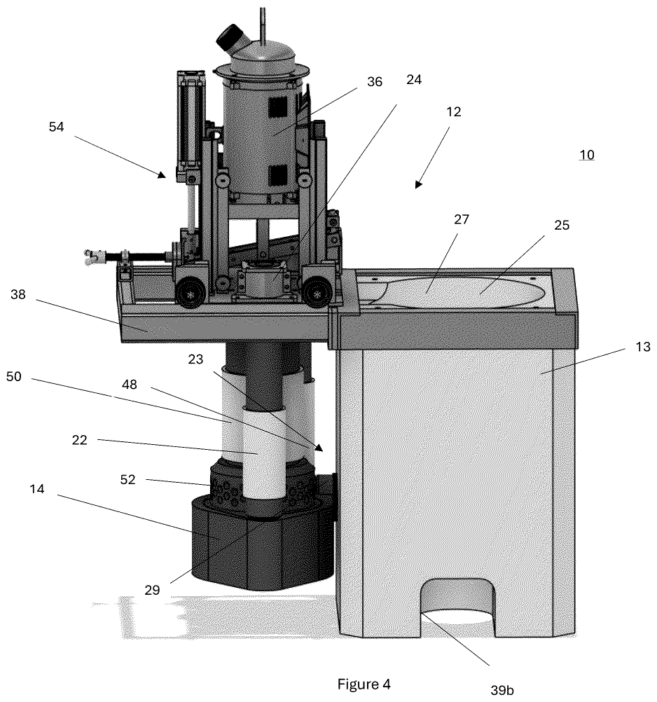

Referring to FIGS. 4, 7, 8 and 12, a well 10 of a furnace includes a pump 12 of the disclosure. Molten metal traveling out of the pump 12 is transferred to a remote location for performing another operation, is directed into a vortexer vessel 13 for scrap melting, and/or circulates through the furnace. The pump for pumping molten metal 12 includes a refractory base 14, which includes at least one inlet 16, a first outlet 18 and a second outlet 20. A transfer riser 22 extends from the base to a location above the molten metal for molten metal transfer. The transfer riser 22 is adapted (e.g., using coupling 24) to be connected to conduit or a launder that extends to discharge into another vessel for transport, for example, to a ladle, a holding furnace and then to a casting location. The first outlet 18 is a discharge opening from the base and the second outlet 20 is an outlet from the base that extends into the bottom of the transfer riser 22. The base 14 includes a first (e.g., lower) volute chamber 24 and a second (e.g., upper) volute chamber 26 that is stacked relative to (disposed above) the first volute chamber 24. In particular, the first and second volute chambers 24, 26 are driven by impeller 28 that is fastened to shaft 30 when rotating in either volute chamber 24, 26. The first volute chamber 24 includes a first volute 32 that is constructed and arranged in a first volute orientation in a top view. The second volute chamber 26 includes a second volute 34 that is constructed and arranged in a second volute orientation opposite to the first volute orientation in a top view. The pump 12 includes a reversible motor 36 when having its completed assembly. Also in its completed assembly, a metal motor mount plate or platform 38 supports the motor 36 above the base. The refractory shaft 30 is connected to the drive shaft of the motor 36. The impeller 28 is connected to an end portion of the refractory shaft 30 with a particular fastener and/or adhesive 37. Referring to FIG. 7, the impeller 28 includes at least one impeller bearing ring 40 and there is an upper bearing ring 42 in the second volute chamber 26, a lower bearing ring 44 in the first volute chamber 24 and a middle bearing ring 46 located between them, which are adapted to receive the impeller 28 and its impeller bearing ring 40 for rotation therein. The bearing rings 40, 42, 44, 46 are made of ceramic and are cemented in place. At least one of a support post 48, the transfer riser 22 and/or a shaft sleeve 50 surrounding the shaft 30 can support the motor mount platform 38 to a location outside the molten metal above the base 14. The base 14, shaft 30 and impeller 28 and portions of the post 48, transfer riser 22, shaft sleeve 50 and vortexer vessel 13 are submerged in the molten metal. A perforated sleeve 52 referred to as the Rock Catcher™ by High Temperature Systems, Inc. is optionally disposed between the shaft sleeve and the base. All components of the pump 12 that are in contact with the molten metal are made of a non-metal, refractory material such as graphite or ceramics.

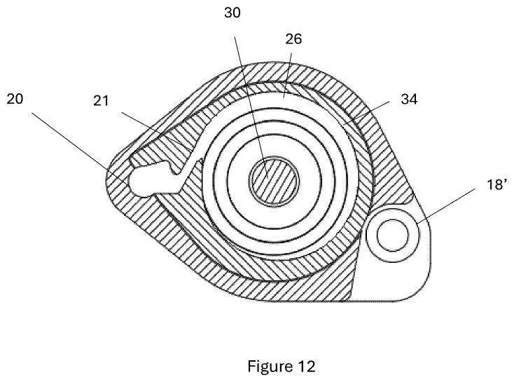

The impeller 28 is rotated in the first volute 32 in one rotational direction relative to a top view to direct molten metal through the first outlet 18 (FIG. 8). The impeller rotational direction (single arrows) and explanation of the direction of the first volute bias (double arrows) are shown in FIG. 8 and provided below. In another operation, the impeller 28 is vertically moved and rotated in the second volute 34 in an opposite rotational direction relative to a top view to direct molten metal through the second outlet 20 (FIG. 12). For example, the first rotational direction is clockwise relative to the top view and the second rotational direction is counter-clockwise relative to the top view.

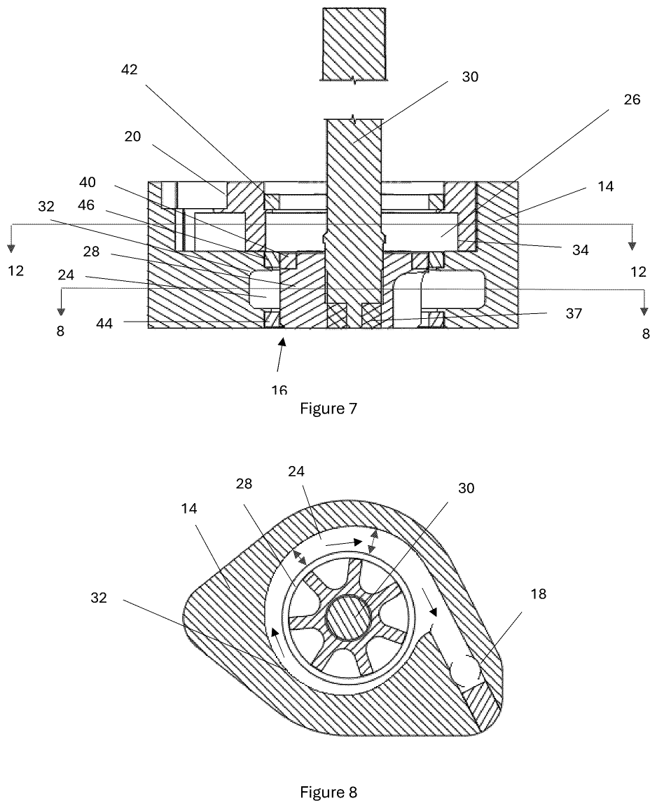

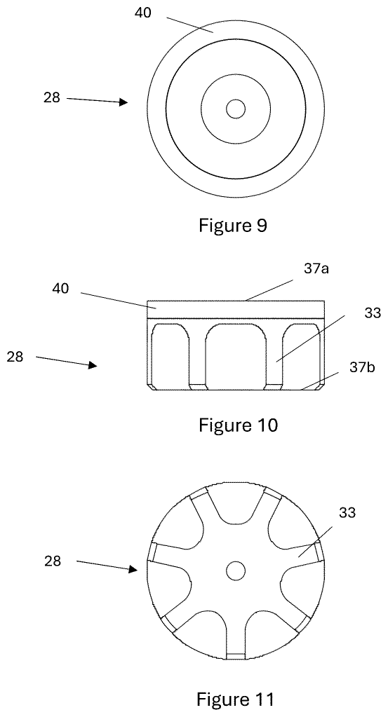

Referring to FIGS. 9-11, the impeller 28 has an upper surface 37a and a lower surface 37b. The impeller bearing ring 40 is fastened to the impeller 28. Molten metal is inlet into the impeller through the bottom and vanes 33 apply force that rotates the molten metal inside the impeller chamber. The vanes are shown as extending straight from a central portion of the impeller radially outward to its periphery. The vanes or passages extend along the shaft and normal to the shaft radially outward from near a center portion of the impeller. The vanes and passages could have a variety of other designs, for example, the vanes could also be curved, or the vanes could have faces that are substantially tangential to a central portion of the impeller (FIG. 15). A squirrel cage impeller could be used. The impeller can include a selection of the pitch, size and shape of vanes and/or passages that are designed for the efficient, particular impeller rotation.

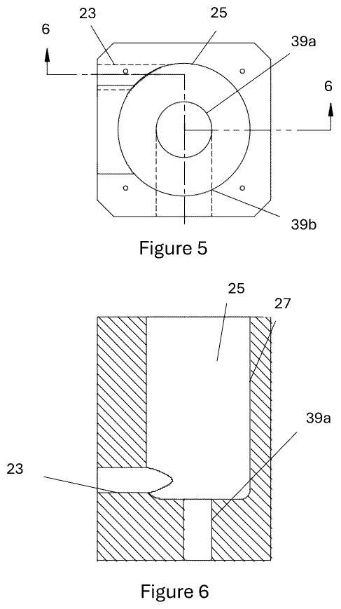

Referring to FIGS. 5 and 6 the vortexer vessel 13 includes an inlet opening 23 into a bowl 25 of the vortexer vessel along which the molten metal is inlet from the pump into the bowl. The bowl includes an outer wall 27. The inlet opening 23 is offset from the centerline of the bowl (e.g., the inlet opening is substantially tangential to the outer wall of the bowl) (FIG. 5), as shown in the design of the vortexer vessel similar to the Coriolis block made by High Temperature Systems and disclosed in U.S. Pat. No. 7,497,988, which is incorporated herein by reference in its entirety. Differences are that here there is only one inlet opening into the vortexer bowl and the vortexer inlet opening is below the level of the bath in the furnace well. The vortexer vessel 13 can be located adjacent to the base 14 at least partially submerged inside the molten metal, wherein molten metal from the first outlet 18 is directed through the inlet opening 23, into the vortexer vessel effective to create a vortex that pulls metal scrap down into the vortexer vessel for melting the scrap. In the design shown, the first outlet 18 is in fluid communication with a section of riser and elbow 29 which is adapted to be fastened to a side of the vortexer vessel 13. Molten metal leaves the vortexer vessel and travels in the furnace through outlet passages 39a, 39b.

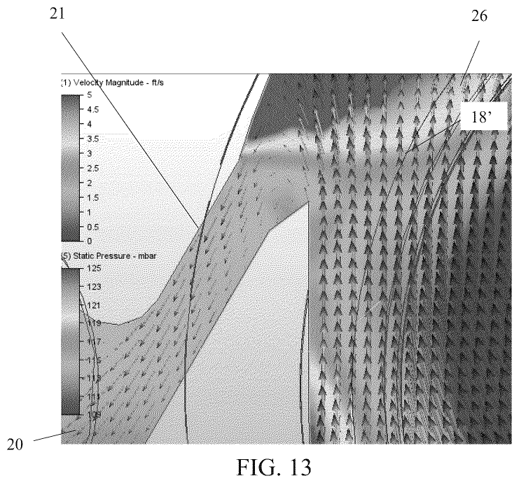

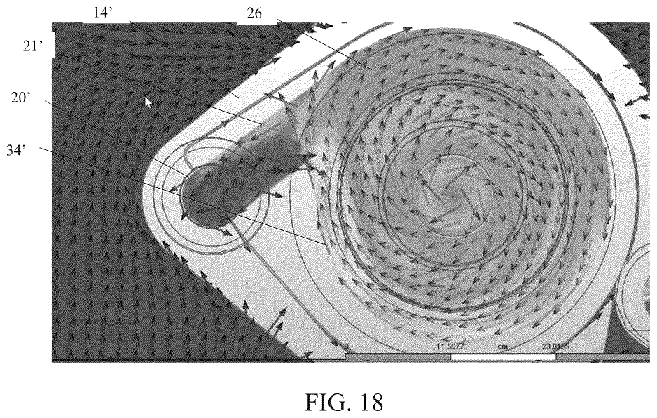

Rotation of the impeller 28 in the first volute chamber 24, as an active volute chamber, (FIG. 8) causes flow of molten metal in the second volute chamber 26, as an inactive volute chamber (illustrated in the related base design of FIG. 18). However, travel of the molten metal up the transfer riser 22 is impeded by the second volute orientation that is opposite to the first volute orientation. The rotation direction of substantial flow of molten metal, clockwise by the arrows in FIGS. 13 and 18, in the second volute chamber 26 when it is inactive, is opposite to the counter-clockwise bias direction of the second volute 34 (FIG. 12). By “direction of substantial flow of molten metal” in the inactive volute (shown in FIGS. 13 and 18) is meant a direction of substantially all of the flow of molten metal, the majority of the arrows, in the inactive volute (rather than directions of minor portions of flow).

A lifting mechanism 54 is constructed and arranged for vertically moving the impeller 28, 28′ connected to the shaft 30 between one vertical position in the first volute and another vertical position in the second volute, as described for use with the Chameleon® pump disclosed in U.S. Pat. No. 9,494,366, which is incorporated herein by reference in its entirety.

The present disclosure uses the fact that the volute shape is biased towards a certain direction for higher efficiency, and switches the preferred direction of rotation between the two volute chambers 24, 26. Reference to the volute shape being biased toward a direction of higher efficiency is also described herein as “first volute orientation” and “second volute orientation.” A volute orientation refers to volute shape in which the distances between the side of the impeller and a side wall of the volute chamber, transverse to the impeller axis, progressively increase in a direction around a portion of the impeller circumference toward the outlet. The first volute 32, going toward the first outlet 18, is biased in a first direction (e.g., a first or clockwise volute orientation in a top view)(FIG. 8), and the second volute 34, going toward the second outlet 20, is biased in a second direction (e.g., a second or counter-clockwise volute orientation in a top view) (FIG. 12).

FIG. 8 shows an active first volute chamber 24 having a clockwise volute 32 orientation, going toward the first outlet 18, which employs a clockwise rotating impeller. In the first volute 32 shown, the volute orientation (clockwise volute bias direction) comprises a volute shape in which the distances shown by the double arrows, transverse to the axis of the shaft 30, progressively increases in a clockwise direction around a portion of the impeller circumference toward the first outlet 18.

FIG. 12 shows the second volute chamber 26 of the present disclosure, which contrasts with volute chamber B of PRIOR ART FIG. 3, but does not show a spinning impeller therein. The second volute chamber 26 is inactive in the view shown in FIG. 12. FIG. 12 shows the second volute chamber 26 including a second counter-clockwise volute 34 orientation wherein the impeller will be spinning in a counter-clockwise direction directing molten metal to the second outlet 20 at higher efficiency. This requires the motor to operate to reverse the rotation of the impeller in the second volute chamber 26 (e.g., counter-clockwise) versus rotation of the impeller in the first volute chamber 24 (e.g., clockwise). In a particular design the impeller is positioned and rotates in one volute chamber separately from the impeller position and rotation in the second volute chamber.

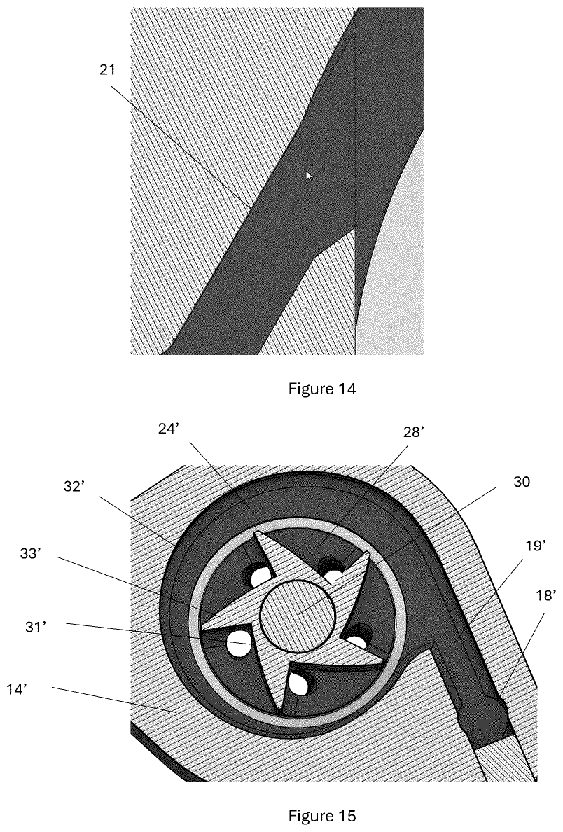

FIG. 13 is a nonlimiting example during operation that shows the velocity magnitude in the inactive second volute 34 (arrows) and static pressure (mbar) in the second volute 34 and second outlet 20. The switched counter-clockwise second volute 34 orientation design of the base (relative to the clockwise first volute 32 orientation and to the clockwise substantial direction of induced flow in the second volute 34) applies pressure and velocity less effectively inside the second volute toward the second outlet 20. Fluid moving along the outer wall of the second volute 34 will pass the cutwater of the second volute 34 leading to the second outlet 20 about 150° from the tangential passageway 21 (e.g., FIG. 14), and flows along the tangential passageway 21 into second outlet 20. This angle being greater than 90° decreases the pressure inside the tangential passageway 21, and by extension the pressure of fluid inside the second outlet 20.

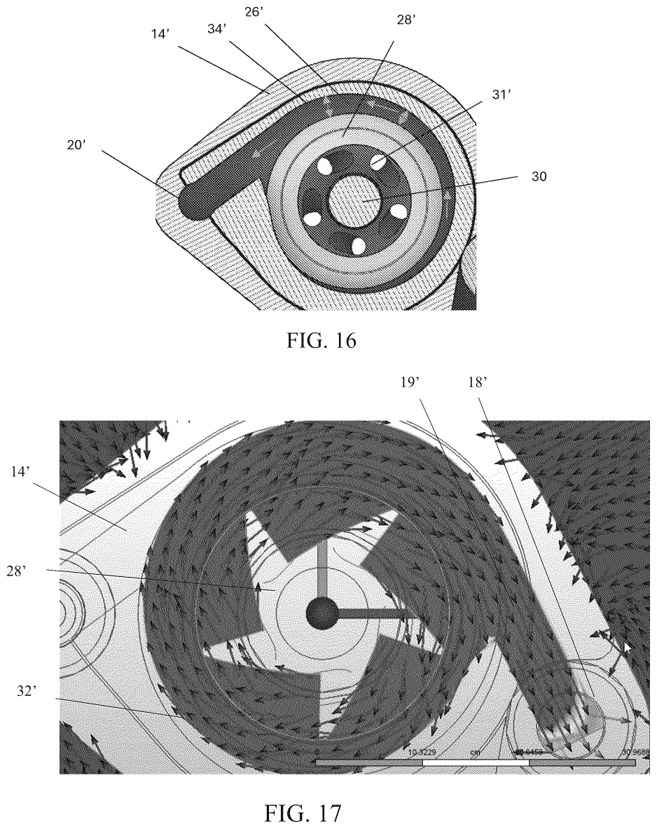

Another embodiment is shown in FIGS. 15 and 16, where like parts share like reference numerals throughout the several views, including active first volute 32′ and active second volute 34′, respectively. In this design the first volute 32′ orientation of FIG. 15 corresponds to a clockwise bias direction. In the active volute operation the impeller of FIG. 15 (such as for directing molten metal into the vortexer vessel for melting scrap) is rotated clockwise. During operation, as shown in FIG. 15 (top view), molten metal flow occurs inside the active first volute chamber, wherein the impeller 28′ is rotated clockwise in the first volute 32′ having a clockwise volute orientation and directs the molten metal to the first outlet 18′ (e.g., for discharge into a scrap melting vortexer vessel and/or circulation in the furnace). A tangential passageway 19′ extends from the first volute 32′ to the first outlet 18′. It is evident that the molten metal flows at high velocity in the active first volute chamber 24′ and through the first outlet 18′ (see FIG. 17 in which red denotes high velocity). This impeller 28′ includes passages 31′ (lower inlets into the first volute chamber 24) and vanes 33′.

Referring to FIG. 16, the second volute 34′ orientation corresponds to a counter-clockwise bias direction. In the active volute operation shown the impeller of FIG. 16 (such as for transferring molten metal to a ladle) is rotated counter-clockwise. In the second volute 34′ shown, the volute orientation (counter-clockwise volute bias direction) comprises a volute shape in which the distances shown by the double arrows, transverse to the axis of the shaft 30, progressively increase in a counter-clockwise direction around a portion of the impeller circumference toward the second outlet 20′. In the prior art pump of FIGS. 1-3, volutes A and B, go to outputs 1 and 2, respectively, and both volutes are biased in a clockwise direction (i.e., the volutes A and B both have the same clockwise volute orientation). This means that in prior art FIGS. 1-3 the distances between the impeller and the side wall of the volute progressively increase in the clockwise direction around a portion of the impeller circumference toward the outlet. In contrast, according to this disclosure, in order to reduce the impact that the molten metal rotation inside the active first volute chamber 24′ has on molten metal rotation inside the inactive second volute chamber 26′ (induced rotation) (FIGS. 13 and 18), the second volute 34′ is biased towards the opposite direction than the first volute 32′. Moreover, the counter-clockwise second volute bias direction is opposite to the clockwise, induced substantial flow direction of molten metal in the inactive second volute (FIG. 18). FIG. 18 (top view) shows the induced molten metal flow of the inactive second volute 34′ while the impeller is spinning below in the active first impeller chamber. The molten metal travels in a substantially clockwise direction in the inactive second volute 34′ to the second outlet 20′, with the second volute 34′ being biased in a counter-clockwise direction (i.e., a second or counter-clockwise volute orientation in a top view). The tangential passage 21′ extends from the second volute 34′ to the second outlet 20′. It can be seen from FIG. 18 that the direction of substantial flow of the molten metal is rotating clockwise in the inactive second volute 34′ containing no spinning impeller, against the counterclockwise bias direction of the second volute 34′, which causes pressure and velocity to be applied less effectively inside the second volute toward the second outlet 20. This impedes the molten metal from traveling above the resting metal line inside the transfer riser 22 in the case of the inactive second volute 34′. It is evident that the molten metal velocity inside the inactive volute 34′ and the second outlet 20′ is slow and there is minimal flow in the transfer riser 22. At the time shown in FIG. 18 the pumping operation of the first volute chamber 24 is directing the molten metal to the vortexer vessel 13 or for circulation in the furnace.

In particular, one of the volute chambers 24, 26, or 24′, 26′ is machined to be operated in the reverse bias direction as the other. Moreover, the impeller 28, 28′can be designed to function well enough in both directions of rotation. For example, the impeller can include straight vanes. A squirrel cage impeller can also be used having straight passages. In contrast, it is often the case that a prior art impeller is only designed for only one rotational direction. The impeller can also be designed to include directional vanes and/or passages, including curved vanes and passages. Some additional considerations are that the typical right-handed threads used to assemble the shaft and the impeller of the pump must either be permanently attached using adhesives or other methods, or the impeller-shaft joint must be done with a method that will not cause it to unscrew the impeller when rotating in a reverse direction. The motor used must also be easily reversible.

It should be appreciated by those of ordinary skill in the art in view of this disclosure that the lower first volute chamber 24, 24′ could be connected to the second outlet 20, 20′ (e.g., for traveling up the transfer riser) and the upper volute chamber outlet 26, 26′ could be connected to the first outlet 18, 18′ (e.g., for discharge into the vortexer vessel for melting scrap or for furnace circulation).

Moreover, although higher efficiency can be achieved using the dual volute design, the lower impeller chamber can be voluteless or substantially voluteless. For example, the impeller chamber could be circular and the impeller is rotated with an equidistant spacing between the impeller side wall and the side wall of the impeller chamber around the circumference of the impeller in a direction toward the outlet. A voluteless impeller chamber need not be circular in a top view. Also, small components or pieces machined into or fastened to a side wall of an impeller chamber might not avoid the impeller chamber from being considered substantially voluteless. As used herein, the term volute means a structure in an impeller chamber of the base that reduces velocity of fluid to increase pressure in a specific direction toward an outlet of the impeller chamber, fluid being expelled from the outlet having highest pressure in the volute. In nonlimiting examples shown in the drawings the volute has a shape of increasing radius around a central point ending in an outlet portion that extends in a direction tangential to the expanding radius leading to the outlet (e.g., FIGS. 8 and 12).

The base can be top inlet only, bottom inlet only or top and bottom inlets. In particular, the base is a bottom inlet only.

Many modifications and variations will be apparent to those of ordinary skill in the art in light of the foregoing disclosure. Therefore, it is to be understood that, within the scope of the appended claims, the invention can be practiced otherwise than has been specifically shown and described.

What is claimed is:

1. A pump for pumping molten metal comprising
a refractory base including at least one inlet, a first outlet, a second outlet, a first volute chamber and a second volute chamber disposed above said first volute chamber;
wherein said first volute chamber includes a first volute that is constructed and arranged in a first volute orientation in a top view and said second volute chamber includes a second volute that is constructed and arranged in a second volute orientation opposite to said first volute orientation in a top view;
a motor driven, refractory shaft and an impeller connected to an end portion of said refractory shaft, wherein said impeller is rotated in said first volute in one rotational direction relative to a top view to direct molten metal through said first outlet and said impeller is vertically moved and rotated in said second volute in an opposite rotational direction relative to a top view to direct molten metal through said second outlet.

2. The pump for pumping molten metal of claim 1 comprising a transfer riser extending from said base outside the molten metal for molten metal transfer, wherein said first outlet is a discharge opening of said base and said second outlet is an outlet from said base extending into said transfer riser.

3. A system including the pump of claim 2 comprising a vortexer vessel located adjacent to said base and comprising at least one well of a furnace in which said pump and said vortexer vessel are partially submerged, wherein molten metal from said first outlet is directed into said vortexer vessel effective to create a vortex that pulls metal scrap down into the vortexer vessel for melting the scrap.

4. The system of claim 3, wherein molten metal traveling through said first outlet travels into a bowl of said vortexer, the vortex of molten metal is formed in the bowl, the molten metal outlets from said bowl and circulates through said furnace.

5. The system of claim 3 wherein said vortexer vessel includes an inlet opening into a bowl of said vortexer vessel along which the molten metal is inlet from the pump into said bowl, said inlet opening being substantially tangential to a side wall of said bowl.

6. The pump of claim 2 wherein said transfer riser is connected to conduit or a launder that extends to be adapted to discharge at a remote location.

7. The pump of claim 1 wherein said first rotational direction is clockwise relative to the top view and said second rotational direction is counterclockwise relative to the top view.

8. The pump of claim 1 comprising a lifting mechanism for carrying out said vertical movement of said impeller that vertically moves said shaft and said impeller between one vertical position in said first volute and another vertical position in said second volute.

9. The pump of claim 1 wherein said impeller is selected from one of the following: said impeller includes a plurality of straight vanes, straight passages or a combination thereof, wherein the straight vanes or straight passages extend along said shaft and normal to said shaft radially outward from near a center portion of said impeller; said impeller has curved vanes; and said impeller has vanes with faces that extend outward from and substantially tangential to a central portion of the impeller.

10. A pump for pumping molten metal comprising
a refractory base including at least one inlet, a first outlet, a second outlet, a transfer riser extending from said base outside the molten metal for molten metal transfer, wherein said first outlet is a discharge opening of said base and said second outlet is an outlet from said base extending into said transfer riser, a first volute chamber and a second volute chamber disposed above said first volute chamber;
wherein said first volute chamber includes a first volute that is constructed and arranged in a first volute orientation in a top view and said second volute chamber includes a second volute that is constructed and arranged in a second volute orientation opposite to said first volute orientation in a top view;
a motor driven, refractory shaft and an impeller connected to an end portion of said refractory shaft, wherein said impeller is rotated in said first volute in a first rotational direction relative to a top view to direct molten metal through said first outlet and said impeller is vertically moved and rotated in said second volute in a second rotational direction opposite to said first rotational direction relative to a top view to direct molten metal through said second outlet;
wherein a rotating of said impeller in said first volute or said second volute is an active volute and lack of a rotating said impeller in said first volute or said second volute is an inactive volute;
wherein rotation of said impeller in said first volute, as the active volute, causes a direction of substantial flow of molten metal in said second volute, as the inactive volute, but travel of said molten metal up said transfer riser is impeded by said second volute orientation that is opposite to said direction of substantial flow in said second volute.

11. The pump of claim 10 comprising a lifting mechanism for carrying out said vertical movement of said impeller that vertically moves said shaft and said impeller between one vertical position in said first volute and another vertical position in said second volute.

12. A system comprising the pump of claim 10 comprising a vortexer vessel located adjacent to said base and comprising at least one well of a furnace in which said pump and said vortexer vessel are partially submerged, wherein molten metal from said first outlet is directed into said vortexer vessel effective to create a vortex that pulls metal scrap down into the vortexer vessel for melting the scrap.

13. The system of claim 12, wherein molten metal traveling through said first outlet travels into said bowl, the vortex of molten metal is formed in the bowl, the molten metal outlets from said bowl and circulates through said furnace.

14. The system of claim 12 wherein said vortexer vessel includes an inlet opening into a bowl of said vortexer vessel along which the molten metal is inlet from the pump into said bowl, said inlet opening being substantially tangential to a side wall of said bowl.

15. The pump of claim 10 wherein said transfer riser is connected to conduit or a launder that extends to discharge into a movable vessel.

16. The pump of claim 10 wherein said first rotational direction is clockwise relative to the top view and said second rotational direction is counterclockwise relative to the top view.

17. The pump of claim 10 wherein said impeller is selected from one of the following: said impeller includes a plurality of straight vanes, straight passages or a combination thereof, wherein the straight vanes or straight passages extend along said shaft and normal to said shaft radially outward from near a center portion of the impeller; said impeller has curved vanes; and said impeller has vanes with faces that extend outward from and substantially tangential to a central portion of the impeller.

18. A pump for pumping molten metal comprising
a refractory base including at least one inlet, a first outlet, a second outlet, a first impeller chamber and a second impeller chamber disposed above said first impeller chamber;
wherein said first impeller chamber is substantially voluteless or includes a first volute and said second volute chamber includes a second volute, wherein if used, said first volute has a first volute orientation that is opposite to said second volute orientation;
a motor driven, refractory shaft and an impeller connected to an end portion of said refractory shaft, wherein said impeller is rotated in said first impeller chamber in one rotational direction relative to a top view to direct molten metal through said first outlet and said impeller is moved vertically and rotated in said second volute in an opposite rotational direction relative to a top view to direct molten metal through said second outlet;
wherein a rotating said impeller in said first impeller chamber or said second impeller chamber is an active impeller chamber and lack of a rotating said impeller in said first impeller chamber or said second impeller chamber is an inactive impeller chamber;
wherein rotation of said impeller in said first impeller chamber, as the active impeller chamber, causes a direction of substantial flow of molten metal in said second impeller chamber, as the inactive impeller chamber, but travel of said molten metal up said transfer riser is impeded by said second volute orientation that is opposite to said direction of substantial flow in said second impeller chamber.

19. The pump for pumping molten metal of claim 18 comprising a transfer riser extending from said base outside the molten metal for molten metal transfer, wherein said first outlet is a discharge opening of said base and said second outlet is an outlet from said base extending into said transfer riser.

20. A system comprising the pump of claim 19 comprising a vortexer vessel located adjacent to said base and comprising at least one well of a furnace in which said pump and said vortexer vessel are partially submerged, wherein molten metal from said first outlet is directed into said vortexer vessel effective to create a vortex that pulls metal scrap down into the vortexer vessel for melting the scrap.

21. The system of claim 20 wherein molten metal traveling through said first outlet travels into a bowl of said vortexer vessel, the vortex of molten metal is formed in said bowl, the molten metal outlets from said bowl and circulates through said furnace.

22. The system of claim 20 wherein said vortexer vessel includes an inlet opening into a bowl of said vortexer vessel along which the molten metal is inlet from the pump into said bowl, said inlet opening being substantially tangential to a side wall of said bowl.

23. The pump of claim 19 wherein said transfer riser is connected to conduit or a launder that extends to be adapted to discharge into a movable vessel.

24. The pump of claim 18 comprising a lifting mechanism for carrying out said vertical movement of said impeller that vertically moves said shaft and said impeller between one vertical position in said first impeller chamber and another vertical position in said second impeller chamber.

25. The pump of claim 18 wherein said impeller is selected from one of the following: said impeller includes a plurality of straight vanes, straight passages or a combination thereof, wherein the straight vanes or straight passages extend along the shaft and normal to the shaft radially outward from near a center portion of the impeller; said impeller has curved vanes; and said impeller has vanes with faces that extend outward from and substantially tangential to a central portion of said impeller.
